(19) United States
(12) Patent Application Publication
(10) Pub. No.: US 2010/0131803 A1
(43) Pub. Date: May 27, 2010

(54) COMPUTATION OF STACK USAGE IN EMBEDDED COMPUTING SYSTEMS

(75) Inventors: William E. Lamie, Poway, CA (US); Yuxin Zhou, San Diego, CA (US)

Correspondence Address: FITCH EVEN TABIN & FLANNERY, 120 SOUTH LASALLE STREET, SUITE 1600, CHICAGO, IL, 60603-3406, US

(73) Assignee: Express Logic, San Diego, CA (US)

(21) Appl. No.: 12/323,366

(22) Filed: Nov. 25, 2008

(51) Int. Cl. G06F 11/36; G06F 9/45

(52) U.S. Cl. 714/38; 717/157; 714/E11.207

(57) ABSTRACT

A method to facilitate memory allocation includes examining an executable program file configured to be executed by a processor to identify a group of functions present within the executable program file, and calculating memory requirements for each function of the group of functions. Further operations include identifying a plurality of root functions as functions which are not referred to by other functions, creating a function call tree for each of the plurality of root functions, such that each of the function call trees comprise functions which are directly or indirectly referred to by an associated one of the plurality of root functions, and calculating memory requirements for one or more function call paths of each of the function call trees based upon the calculated memory requirements of the functions included within the one or more function call paths.

### BACKGROUND OF THE INVENTION

1. Field of the Invention

The present invention relates generally to embedded systems, and more specifically to a method to facilitate memory allocation.

2. Discussion of the Related Art

One common problem that programmers encounter is determining how much memory to allocate to stacks in an embedded system. If the size of a stack exceeds the amount of stack memory allocated by the programmer, the program will likely result in a catastrophic failure. Therefore, it is typically desirable for correct operation of a program that enough stack is allocated for a worst case scenario. This leaves a programmer with the uneasy trade-off between making the stack too small and risking stack overflows, or making it larger than necessary and wasting memory and address space, for example.

There is no simple way for a programmer to determine precisely how much stack memory to allocate. Hence, it is common for programmers to rely on trial and error. methods to determine the stack size for the operating system and for each thread in the system. This testing-based method is to initially make a large estimate of stack size and refine the guess after observing stack depth during actual or simulated runs of the system. However, this method is tedious and imprecise, and there are many variables that make accurate prediction of the actual stack usage beyond the capability of most programmers. Moreover, programmers often end up allocating a stack size that is more than necessary to avoid stack overflow, or less than necessary because the actual needs of the program cannot be easily anticipated. Several trials may yield success, but subsequent use of the program can result in greater stack memory needs than previously encountered, causing a program to fail as a result.

One method to solve this problem is to analyze the source code of the program to determine the maximum stack memory usage for any possible path and verify that enough stack memory has been allocated. However, an analysis based solely on the high-level language source code is likely to be incomplete. Other approaches involve analyzing the assembly language since it is commonly understood that compilers add function calls not present in the source code. However, it is recognized that the worst case maximum stack memory usage of the program cannot be determined using this method unless information is provided by the compiler vendor.

### SUMMARY OF THE INVENTION

In one embodiment, the invention can be characterized as a method to facilitate memory allocation, and includes examining an executable program file configured to be executed by a processor to identify a group of functions present within the executable program file, and calculating memory requirements for each function of the group of functions. Further operations include identifying a plurality of root functions as functions which are not referred to by other functions, creating a function call tree for each of the plurality of root functions, such that each of the function call trees comprise functions which are directly or indirectly referred to by an associated one of the plurality of root functions, and calculating memory requirements for one or more function call paths of each of the function call trees based upon the calculated memory requirements of the functions included within the one or more function call paths.

In another embodiment, the invention can be characterized as a computer-readable medium for facilitating memory allocation, the computer-readable medium tangibly storing instructions which, when executed by a processor, cause the processor to perform various operations. Such operations include examining an executable program file configured to be executed by a processor to identify a group of functions present within the executable program file, calculating memory requirements for each function of the group of functions, identifying a plurality of root functions as functions which are not referred to by other functions, and creating a function call tree for each of the plurality of root functions, such that each of the function call trees comprise functions which are directly or indirectly referred to by an associated one of the plurality of root functions. A further operation includes calculating memory requirements for one or more function call paths of each of the function call trees based upon the calculated memory requirements of the functions included within the one or more function call paths.

In a further embodiment, the invention can be characterized as a method to facilitate memory allocation that includes examining an executable program file configured to be executed by a processor located within an embedded system to identify a group of functions present within the executable program file, calculating memory requirements for each function, and identifying a plurality of root functions which are not referred to by other functions of the group of functions. Further operations include creating a function call tree for each of the plurality of root functions, such that each of the function call trees comprise functions of the group of functions which are directly or indirectly referred to by an associated one of the plurality of root functions, calculating stack memory requirements for one or more function call paths of each of the function call trees based upon the calculated memory requirements of the functions included within the one or more function call paths, and estimating stack memory requirements for each of the function call trees based upon which of the calculated memory requirements of the one or more function call paths requires a greatest amount of memory. Another operation relates to determining a memory overflow error that would be caused by execution of the executable program file based upon the stack memory requirements for one or more function call paths of at least one of the function call trees exceeding a memory threshold.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 depicts an exemplary embedded system implementing stack memory which has been allocated in accordance with various embodiments of the present invention.

FIG. 2 depicts two function call tress which may be created in accordance with an embodiment of the present invention.

FIG. 3 is a flowchart depicting a method to facilitate memory allocation in accordance with an embodiment of the present invention.

FIG. 4 depicts an example of a computing environment within which the various memory allocation techniques disclosed herein may be either fully or partially implemented, in accordance with yet another embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

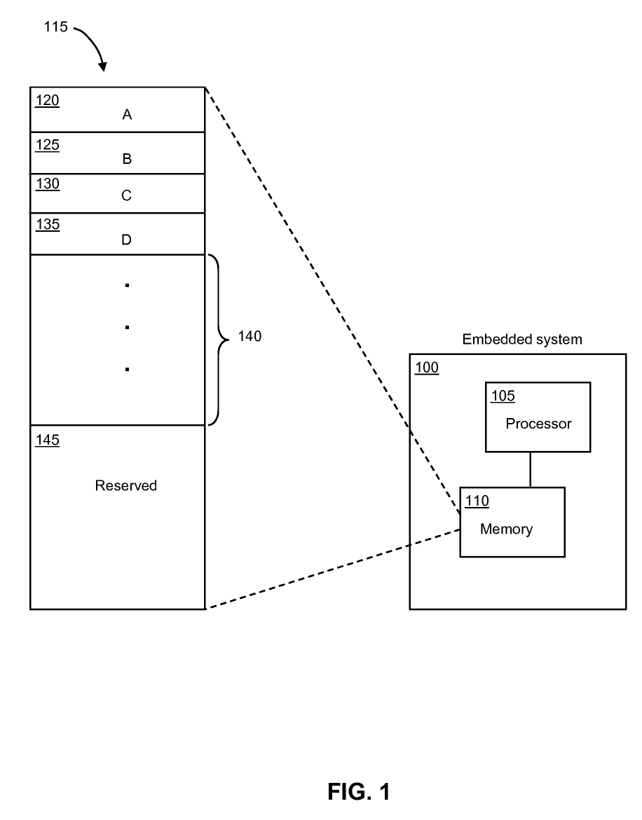

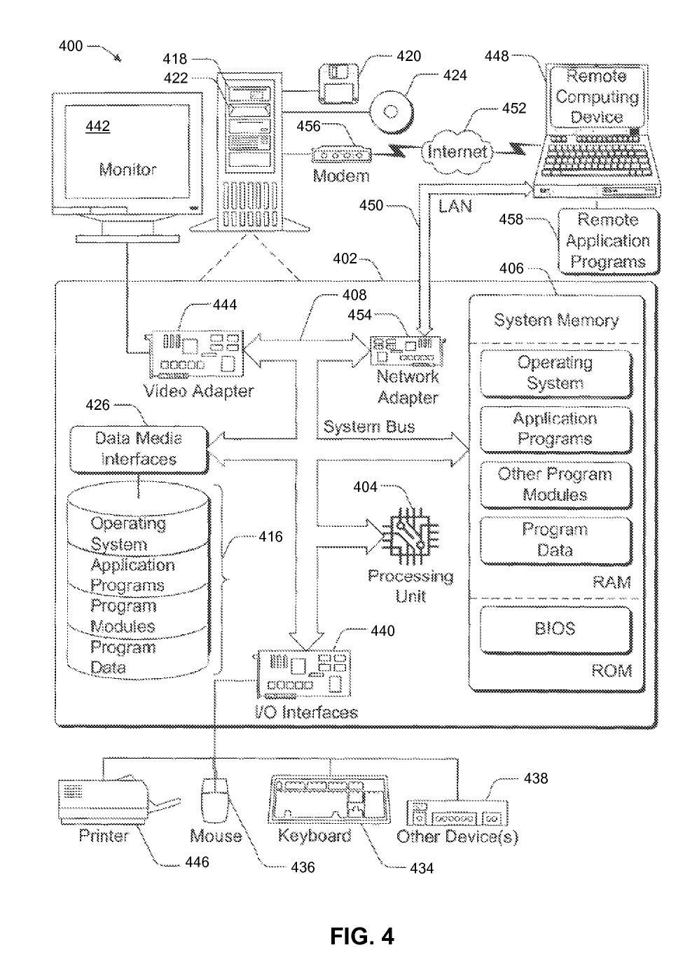

FIG. 1 depicts an exemplary embedded system implementing stack memory which has been allocated in accordance with various embodiments of the present invention. In particular, embedded system 100 includes processor 105 and associated memory 110. A portion of memory 110 includes stack 115. Various embodiments will be described in the context of stack memory utilized by an embedded device, but such descriptions apply equally to other systems including, for example, those set out with regard to FIG. 4.

Referring still to FIG. 1, an embedded system, such as system 100, is generally understood to function as a special-purpose computer system designed to perform a limited number of functions. It is usually embedded as part of a complete device including hardware and mechanical parts. A vast assortment of different types of devices may be configured to include an embedded system. For instance, embedded systems are found in assorted consumer electronics including personal digital assistants (PDAs), portable audio players, videogame consoles, digital cameras, digital versatile disc (DVD) players, global positioning system (GPS) receivers, printers, routers, and the like. Telecommunications systems employ numerous embedded systems ranging from telephone switches for the network to mobile phones at the end-user.

Moreover, many household appliances, such as microwave ovens, washing machines and dishwashers, include embedded systems. Transportation systems from flight (e.g., flight control avionics) to automobiles (e.g., safety systems such as anti-lock braking system (ABS), electronic stability control, and automatic four-wheel drive, etc.) increasingly use embedded systems. Aircraft commonly contain advanced avionics such as inertial guidance systems and GPS receivers that also have considerable safety requirements and which are implemented using various types of embedded devices and systems. Medical equipment is continuing to advance with more embedded systems for vital signs monitoring, electronic stethoscopes for amplifying sounds, and various medical imaging applications.

Processor 105 may be implemented using a device which supports the processing requirements of embedded system 100. Examples of such devices include one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

In general, memory 110 may be implemented using any type (or combination) of suitable volatile and non-volatile memory or storage devices including random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, card-type memory, or other similar memory or data storage device. If desired, the processor and memory may alternatively be implemented using any of the processors and memories set forth with regard to FIG. 4.

As embedded system 100 is utilized to accomplish various tasks for which it was designed, it uses memory in order to perform the necessary calculations and manipulations associated with the processes at hand. A portion of this memory may include stack 115, which includes a dedicated portion of the memory for storing data associated with the function. Thus, in an embodiment, stack 115 serves as a temporary storage location for placing interim data while performing various other processing operations. As part of the processing associated with the normal operations of embedded system 100, the embedded system may issue function calls for various procedures or processes, for example. Whenever the system calls a function as part of accomplishing a task, various types of data may be placed onto the stack for use by the system. Examples of this data include the current state of the embedded system, a return address, variables being passed to and from the function, combinations thereof, and the like.

During use, as each function is called, data associated with the function is placed on the stack using, for example, a data or stack frame. In the example of FIG. 1, stack 115 stores data (discussed above) associated with four separate functions as stack frames 120, 125, 130, 135. Region 140 refers to the currently available stack space for a given process or procedure, which again may include a number of different functions. The cumulative stack space for such a process is shown defined by region 140 and the collective memory requirements of stack frames 120 through 135.

In general, each different function call processed during normal operation of embedded system 100 will generate a stack frame that is placed on the stack for eventual removal by the embedded system. One function call generally creates one stack frame. If too many function calls are made and too many stack frames are generated, the stack frames can exceed the logical limits of the stack boundaries and overrun the limits of the stack portion of the memory. In such a scenario, the stack frames will exceed the currently available storage region 140 and overflow or overwrite reserve memory region 145. This type of memory error will commonly cause loss of data and other significant problems. Care is therefore exercised so as not to exceed these boundaries of stack 115. In accordance with various embodiments, such stack overflow errors can be minimized or eliminated using the various techniques disclosed herein.

Embedded system 100 is shown with a single stack 115. However, the embedded system may be designed using a variety of different configurations and stack memory designs. For instance, embedded system 100 may include functionality to provide single-processing or multi-processing. It is common for such multi-processing applications to utilize two or more stacks, each stack being similarly configured as stack 115. In such embodiments, one or more stacks may be implemented for each of the processes.

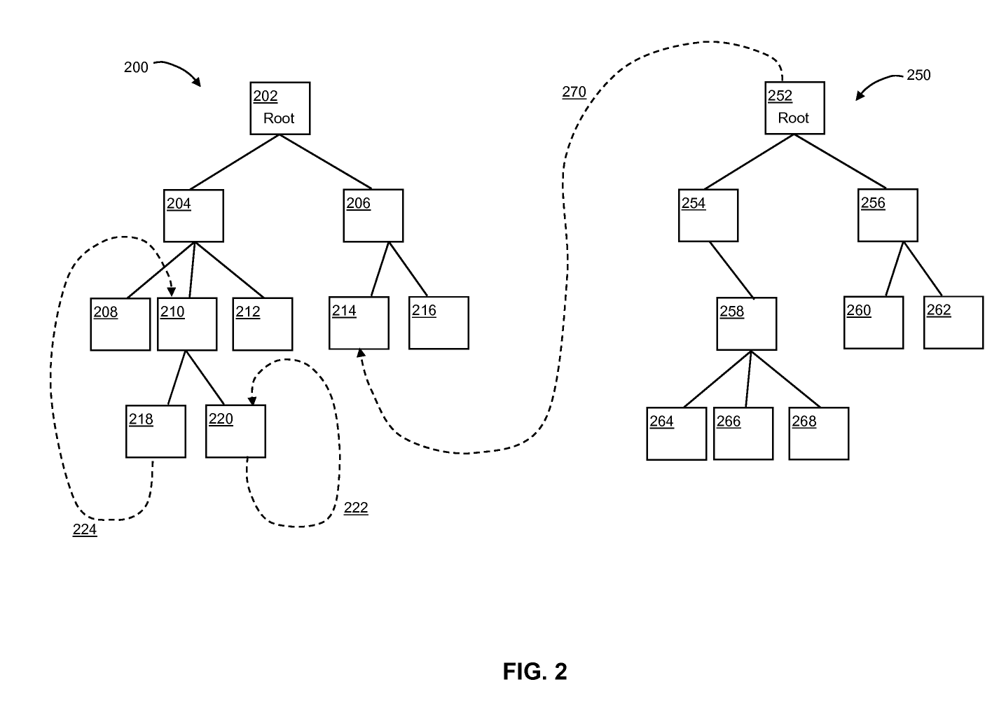

FIG. 2 depicts two function call tress which may be created in accordance with an embodiment of the present invention. In particular, function call tree 200 is shown having four levels that descend from the first level root function 202. Functions 204, 206 are located at the second level, functions 208 through 216 are on the third level, and functions 218, 220 are located on the fourth level. Function 202 is defined as a root function since it is not referred to by any other functions.

In an embodiment, each function of call tree 200 may have been identified by examining an executable program file (e.g., a program executable by processor 105). The functions of call tree 200 may therefore represent functions or procedures present in such an executable program file. It is understood that call tree 200 includes a group of functions which are directly or indirectly referred to by an associated root function 202. In addition, the functions of call tree 200 may be executed in a variety of different manners, referred to herein as call paths. For instance, the various function call paths for function call tree 200 include the following:
202, 204, 208;
202, 204, 210, 218
202, 204, 210, 220
202, 204, 212
202, 206, 214
202, 206, 216.

Each function of function call tree 200 has a particular memory requirement. Accordingly, each call path for the call tree will likewise have a memory requirement, as defined by the collective memory requirements of the functions located within the particular call path. For instance, the call path of 202, 204, and 208 will have a memory requirement defined by the memory requirements of each of three identified functions of the call path. The memory requirements of the other call paths may be calculated in a similar manner.

In some cases, a number of functions of function call tree 200 may be formed, generated, or otherwise provided in the examined executable program file by a compiler used to generate the executable program file. In addition, other functions may stem from associated source code. Accordingly, various embodiments may include functions associated with both the underlying source code as well as functions provided by a compiler.

The calculated memory requirements of the various call paths are useful for a variety of reasons. Consider the example in which the call tree of FIG. 2 is utilized by a programming tool used to assess memory allocation of a program to be executed by an embedded system, such as that which is depicted in FIG. 1. In accordance with various embodiments, the memory requirements for function call tree 200 may therefore be determined or otherwise estimated using, for example, the memory requirements of at least one of the call paths of call tree 200.

In many situations, the memory requirements for function call tree 200 may be defined by the call path which includes functions that collectively require the greatest amount of memory. In some scenarios, the call path with the greatest depth will require the greatest amount of memory. However, other scenarios may occur in which a shorter call path (e.g., 202, 206, 216) will require a greater amount of memory. This scenario may arise since the various functions of call tree 200 may have different memory demands. Thus, it is possible for a shorter call path (e.g., 202, 206, 216) to require a greater amount of memory relative to a longer call path (e.g., 202, 204, 210, 218).

During execution, data associated with each function of a call path may be represented in memory (e.g., in a stack). Using stack 115 of FIG. 1 as an example, data associated with functions 202, 204, 210, and 220 may be stored in stack frames A, B, C, and D, respectively. Data associated with other call paths may be stored in a separate stack in a similar manner. Optimal memory allocation for the stack of a particular process will result in an allocation which will not experience a memory overflow error (e.g., stack frame D overflowing in the memory space of memory reserve 145), while minimizing region 140 after all of the necessary stack frames have been placed onto the stack. In general, this memory allocation is based upon the function call path that requires the greatest amount of memory. One technique for determining a memory overflow error that would be caused by execution of executable program file may be determined based upon the memory requirements of one or more function call paths exceeding a memory threshold.

Various embodiments have been described with regard to estimating stack memory requirements of one or more function call trees based upon the calculated memory requirements of various call paths of the associated call tree. However, a number of alternative features are possible in accordance with other embodiments of the present invention.

One such embodiment relates to identifying recursion with a particular call tree. For instance, FIG. 2 provides an example of both direct and indirect recursive functions. More specifically, function 220 is shown having a direct recursive function 222 such that function 220 refers to itself. In addition, function 218 is shown having an indirect recursive function 224 to the extent that it indirectly refers to itself via intermediate function 210. Although recursion is an acceptable practice in many situations, it is susceptible to errors if the associated function does not include the necessary parameters to break the recursive cycle at some point leading to a stack overflow. Accordingly, program developers often find it useful to be able to identify recursive functions (e.g., via a warning message) when debugging or optimizing program code, for example.

Still further embodiments permit user modification or reallocation of functions associated with various call trees and call paths of a call tree. For instance, FIG. 2 further shows call tree 250 having three levels that descend from the first level root function 252. Functions 254, 256 are located at the second level, functions 258 through 262 are on the third level, and functions 264 through 268 are located on the fourth level. Similar to function 202, function 252 is defined as a root function since it is not referred to by another function.

The modification of a call tree is shown in FIG. 2 as being accomplished by linking operation 270, which links call tree 250 with call tree 200. More specifically, root function 252 is linked to function 214 of call tree 200. This arrangement permits function 214 to refer to function 252 (which is no longer a root function). As a result, call tree 200 includes additional call paths which are defined by the various call paths which consequently stem from function 214. As a part of this modification or reallocation of functions, the memory requirements of these newly created call paths (e.g., 202, 206, 214, 252, 254, 258, 264) may be calculated in manner similar to that described above.

FIG. 2 depicts one such example of linking of functions between call trees. However, it is understood that any function, and any included functions, may also be linked to any other function. In addition, the linking may occur within the same call tree (e.g., linking 206 and included functions with function 212), or with different call trees (e.g., linking function 258 and included functions with function 218). In addition, a typical program will include processes requiring a number of call trees (e.g., from as a few as 2 or 3, to as many as 1,000, or more) that is greater than that the two call trees of FIG. 2. Moreover, each of such call tress may include most any number of functions.

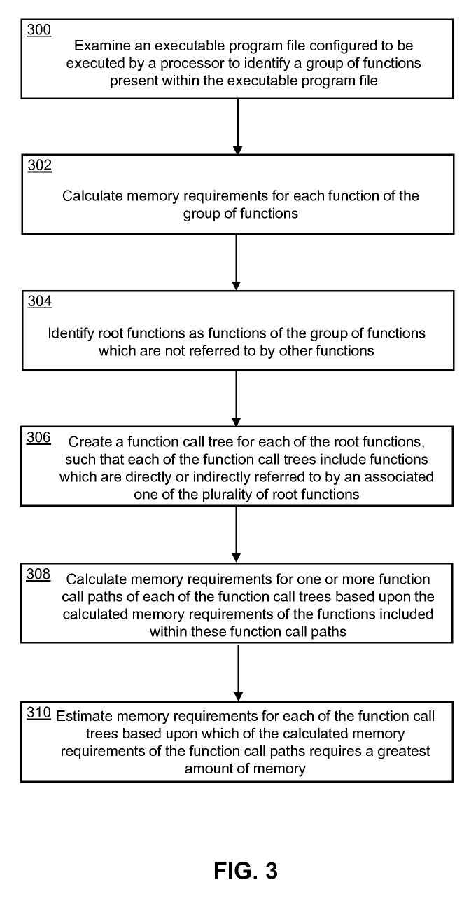

FIG. 3 is a flowchart depicting a method to facilitate memory allocation in accordance with an embodiment of the present invention. Some or all of the operations depicted in this figure may be implemented using a computer-readable media, such as that which is disclosed in more detail with regard to FIG. 4.

Block 300 includes examining an executable program file configured to be executed by a processor (e.g., processor 105) to identify a group of functions present within the executable program file. An example of these functions are the various functions included in call trees 200, 250, of FIG. 2. In various embedded device embodiments, the executable program file is commonly referred to as Extensible Linking Format file (.elf file).

One technique for accomplishing this operation includes obtaining starting and ending memory addresses of each function of the group of functions, and identifying the group of functions based upon these starting and ending memory addresses. In an embodiment, the starting and ending addresses of each function are found through examination of the symbol table which is contained within the executable program file. It is common for a symbol table to be used for mapping human readable function names with their address and size.

In other embodiments, the group of functions include functions associated with source code and at least one compiler-added function which has been added to the executable program file by a compiler of the source code. Such embodiments provide the potential benefit of not being limited to only considering functions associated with the underlying source code, and instead being able to consider functions that are also added by the compiler.

Block 302 recites calculating memory requirements for each function of the group of functions. One method that may be implemented to perform this operation includes scanning a portion of the executable program file associated with each function to identify instructions modifying a memory address pointer, and then calculating the memory requirements for each function of the group of functions based upon an amount of the modifying of the memory address pointer. Another technique for identifying the group of functions present within an executable program file includes scanning binary image data that includes the executable program file.

Block 304 includes identifying a plurality of root functions as functions of the group of functions which are not referred to by other functions. Function 202, 252 are two examples of such root functions.

Block 306 includes creating a function call tree for each of the plurality of root functions. In this operation, each of the function call trees include functions which are directly or indirectly referred to by an associated one of the plurality of root functions. Call trees 200, 250 are two examples of these function call trees.

In an embodiment, creating the function call trees for the root functions includes identifying a group of function calls (e.g., branch-and-link instructions) individually contained within a function and which individually refer to a particular function.

Block 308 recites calculating memory requirements for one or more function call paths of each of the function call trees based upon the calculated memory requirements of the functions included within these function call paths. In some embodiments, the memory requirements for all of the function call paths are calculated.

Optional block 310 includes estimating memory requirements for each of the function call trees based upon the calculated memory requirements of a function call path. In one embodiment, the memory requirements are estimated based upon which function call path requires a greatest amount of memory.

Although the present invention may be implemented using the exemplary series of operations described herein, additional or fewer operations may be performed. Moreover, it is to be understood that the order of operations shown and described is merely exemplary and that no single order of operation is required. In addition, still further features may alternatively or additionally be implemented in accordance with alternative embodiments of the present invention. One such feature relates to estimating memory requirements (e.g., stack memory) for each of the function call trees based upon which of the calculated memory requirements of the one or more function call paths requires a greatest amount of memory.

A further alternative relates to identifying if a function call individually contained within an associated function directly (e.g., recursive function 222) or indirectly (e.g., recursive function 224) refers to itself.

A still further alternative includes linking a first call tree (e.g., call tree 200) with a second call tree (e.g., call tree 250) by causing a particular function of the first call tree to refer to a function of the second call tree. If desired, memory requirements for one or more call paths of the first call tree may then be calculated based upon the calculated memory requirements of the functions included within the one or more function call paths of the first call tree. In some cases, this linking embodiment is performed responsive to user input.

One embodiment relates to detecting a possible memory overflow error, such that such an error would be caused by execution of the executable program file based upon the memory requirements for one or more function call paths of at least one of the function call trees exceeding a memory threshold.

FIG. 4 depicts an example of computing environment 400 within which the various memory allocation techniques disclosed herein, including those of FIG. 3, may be either fully or partially implemented. It is understood that various embodiments implement these memory allocation techniques as a programming tool useful for computer program developers during software design and analysis. For example, a software tool is provided that will perform some or all of the steps of FIG. 3. Such a tool permits users to calculate stack memory requirements, for example, of a particular executable program file. Such embodiments will now be described with regard to FIG. 4.

In particular, computer and network architectures may be implemented with numerous other general purpose or special purpose computing system environments or configurations. Examples of computing systems, environments, and/or configurations that may be suitable for use include personal computers, server computers, thin clients, thick clients, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

Computing environment 400 includes a general-purpose computing system in the form of computer 402. The components of computer 402 may include one or more processors or processing units 404, system memory 406, and system bus 408 that couples various system components including the processor and system memory.

Computer 402 typically includes a variety of computer readable media. Such media can be any available media that is accessible by computer 402 and includes both volatile and non-volatile media, and removable and non-removable media. System memory 406 is shown having computer readable media in the form of volatile memory, such as random access memory (RAM), and/or non-volatile memory, such as read only memory (ROM). A basic input/output system (BIOS), containing the basic routines that help to transfer information between elements within computer 402, such as during start-up, is typically stored in the ROM. The RAM typically contains data and/or program modules that are immediately accessible to and/or presently operated on by processing unit 404.

Computer 402 may also include other removable/non-removable, volatile/non-volatile computer storage media. By way of example, FIG. 4 illustrates hard disk drive 416 for reading from and writing to a non-removable, non-volatile magnetic media, a magnetic disk drive 418 for reading from and writing to a removable, non-volatile magnetic disk 420 (e.g., a floppy disk), and an optical disk drive 422 for reading from and/or writing to a removable, non-volatile optical disk 424 such as a CD-ROM, DVD-ROM, or other optical media. Hard disk drive 416, magnetic disk drive 418, and optical disk drive 422 are shown connected to system bus 408 by one or more data media interfaces 426.

The disk drives and their associated computer-readable media provide non-volatile storage of computer readable instructions, data structures, program modules, and other data for computer 402. Although the example illustrates hard disk 416, removable magnetic disk 420, and removable optical disk 424, it is to be appreciated that other types of computer readable media which can tangibly store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules may be stored on hard disk 416, magnetic disk 420, optical disk 424, system memory 406, including by way of example, an operating system, one or more application programs, other program modules, and program data.

A user, such as a computer program developer, can enter commands and information into computer system 402 via input devices such as keyboard 434 and pointing device 436 (e.g., a mouse). Other input devices 438 (not shown specifically) may include a microphone, joystick, game pad, satellite dish, serial port, scanner, and/or the like. These and other input devices are connected to processing unit 404 via input/output interfaces 440 that are coupled to the system bus 408, but may be connected by other interface and bus structures, such as a parallel port, game port, or a universal serial bus (USB).

Monitor 442 or other type of display device can also be connected to system bus 408 via an interface, such as video adapter 444. In addition to monitor 442, other output peripheral devices can include components such as speakers (not shown) and a printer 446 which can be connected via the input/output interfaces 440.

Computer 402 may also operate in a networked environment using logical connections to one or more remote computers, such as a remote computing device 448. By) way of example, the remote computing device can be a personal computer, portable computer, a server, a router, a network computer, a peer device or other common network node, and the like. The remote computing device is illustrated as a portable computer that can include many or all of the elements and features described herein relative to computer 402.

Logical connections between computer 402 and remote computer 448 are depicted as a local area network (LAN) 450 and a general wide area network (WAN) 452. When implemented in a LAN networking environment, computer 402 is connected to a local network 450 via a network interface or adapter 454. When implemented in a WAN networking environment, computer 402 typically includes modem 456 or other means for establishing communications over the WAN. It is to be appreciated that the illustrated network connections are exemplary and that other means of establishing a communication link between computers 402 and 448 can be employed.

In a networked environment, such as that illustrated with computing environment 400, program modules depicted relative to the computer 402, or portions thereof, may be stored in a remote memory storage device. By way of example, remote application programs 458 reside on a memory device of remote computer 448. For purposes of illustration, application programs and other executable program components, such as the operating system, are illustrated herein as discrete blocks, although it is recognized that such programs and components reside at various times in different storage components of the computer system 402, and are executed by the data processor of the computer.

Various embodiments described herein may be implemented in a computer-readable medium as discussed above. Such embodiments may use, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, such embodiments are implemented by processing unit 404.

For a software implementation, the embodiments described herein, including those set forth with regard to FIG. 3, may be implemented with separate software modules, such as procedures and functions; each of which perform one or more of the functions and operations described herein. The software codes can be implemented with a software application written in any suitable programming language and may be stored in a suitable computer readable medium (for example, system memory 406, drive 416, disk 420, disk 424, etc.), and executed by a controller or processor (for example, processing unit 404). In addition, the executable program file on which the various procedures of FIG. 3 may be performed can be obtained from a variety of different sources. Examples of such sources include local resources (e.g., system memory 406, drive 416, disk 420, disk 424, etc.) or from a remote resource such as remote computing device 448.

Consider next an analysis based upon an executable program file (hello_world_demo.elf). This exemplary program file was examined using some of the techniques described with regard to FIG. 3, the results of-which are set out below. For example, in one embodiment, a software program stored on a computer readable medium, which when executed by a processor, performs one or more or all of steps 300-310 of FIG. 3. In this example, the output file is generated for display to a user. Thus, in this example, the output displays an indication of 8 indirect functions calls and 1 recursive function call. An indirect function call is generally understood as a type of function call that is not specifically called by name.

The analysis set out below refers to MAX STACK DEPTH as used within a call tree to refer to the stack depth at that particular point in the call tree. The term LOCAL STACK relates to stack memory requirements of the associated function. The MAX STACK DEPTH term identified at the start of the analysis reflects the summation of the call tree that has the largest LOCAL STACK requirements. Accordingly, one can see that the MAX STACK DEPTH term at the beginning of the analysis below indicates that the maximum stack depth is 328, which in this example means that the maximum stack depth is 328 bytes. From this information a programmer can determine the amount of stack memory to allocate for the particular executable file. This information may also be used in the development process to correct indirect and/or recursive functions.

The stack memory requirements for each function typically do not vary based upon the operating system used to execute the file. This is because, in many cases, the embedded system utilizes an executable program file that includes both the entire application code and the operating system. When calculating memory allocation, such as that described with regard to FIG. 3, the functions associated with the operating system are treated the same as the functions associated with the application code.

Each function typically includes a particular stack memory requirement, starting at 0 to indicate that no stack memory is necessary. The function's stack memory requirement is typical static. With this understanding, an exemplary analysis based upon an executable program file is presented below.

```
[0x00001000: _mainCRTStartup - MAX STACK DEPTH: 328  LOCAL STACK: 0]
  [0x000010D4: memset - MAX STACK DEPTH: 0  LOCAL STACK: 0]
  [0x00001074: atexit - MAX STACK DEPTH: 184  LOCAL STACK: 16]
    [0x000019D4: _register_exitproc - MAX STACK DEPTH: 168  LOCAL STACK: 24]
      [0x000023A8: malloc - MAX STACK DEPTH: 144  LOCAL STACK: 16]
        [0x00002400: _malloc_r - MAX STACK DEPTH: 128  LOCAL STACK: 40]
          [0x00002C68: _malloc_lock - MAX STACK DEPTH: 0  LOCAL STACK:
0]
          [0x00002C6C: _malloc_unlock - MAX STACK DEPTH: 0  LOCAL STACK:
0]
          [0x00003134: _sbrk_r - MAX STACK DEPTH: 32  LOCAL STACK: 16]
            [0x000017DC: _sbrk - MAX STACK DEPTH: 16  LOCAL STACK: 16]
              [0x00001BE8: _errno - MAX STACK DEPTH: 0  LOCAL STACK:
0]
          [0x00003760: _free_r - MAX STACK DEPTH: 88  LOCAL STACK: 32]
            [0x00002C68: _malloc_lock - MAX STACK DEPTH: 0  LOCAL
STACK: 0]
            [0x00002C6C: _malloc_unlock - MAX STACK DEPTH: 0  LOCAL
STACK: 0]
            [0x00003650: _malloc_trim_r - MAX STACK DEPTH: 56  LOCAL
STACK: 24]
              [0x00002C68: _malloc_lock - MAX STACK DEPTH: 0  LOCAL
STACK: 0]
              [0x00003134: _sbrk_r - MAX STACK DEPTH: 32  LOCAL
STACK: 16]
                [0x000017DC: _sbrk - MAX STACK DEPTH: 16  LOCAL
STACK: 16]
                  [0x00001BE8: _errno - MAX STACK DEPTH: 0
LOCAL STACK: 0]
              [0x00002C6C: _malloc_unlock - MAX STACK DEPTH: 0
LOCAL STACK: 0]
  [0x00001058: main - MAX STACK DEPTH: 328  LOCAL STACK: 8]
    [0x000011BC: puts - MAX STACK DEPTH: 320  LOCAL STACK: 0]
      [0x0000114C: _puts_r - MAX STACK DEPTH: 320  LOCAL STACK: 48]
        [0x000011D4: strlen - MAX STACK DEPTH: 0  LOCAL STACK: 0]
        [0x00001EC4: _sfvwrite - MAX STACK DEPTH: 272  LOCAL STACK: 40]
          [0x00003308: _swsetup - MAX STACK DEPTH: 232  LOCAL STACK: 16]
            [0x00003760: _free_r - MAX STACK DEPTH: 88  LOCAL STACK:
32]
              [0x00002C68: _malloc_lock - MAX STACK DEPTH: 0  LOCAL
STACK: 0]
              [0x00002C6C: _malloc_unlock - MAX STACK DEPTH: 0
LOCAL STACK: 0]
              [0x00003650: _malloc_trim_r - MAX STACK DEPTH: 56
LOCAL STACK: 24]
                [0x00002C68: _malloc_lock - MAX STACK DEPTH: 0
LOCAL STACK: 0]
                [0x00003134: _sbrk_r - MAX STACK DEPTH: 32  LOCAL
STACK: 16]
                  [0x000017DC: _sbrk - MAX STACK DEPTH: 16  LOCAL
STACK: 16]
                    [0x00001BE8: _errno - MAX STACK DEPTH: 0
LOCAL STACK: 0]
                [0x00002C6C: _malloc_unlock - MAX STACK DEPTH: 0
LOCAL STACK: 0]
            [0x000039FC: _smakebuf - MAX STACK DEPTH: 216  LOCAL
STACK: 88]
            [0x00003D5C: _fstat_r - MAX STACK DEPTH: 24  LOCAL
STACK: 16]
                [0x00001840: _fstat - MAX STACK DEPTH: 8  LOCAL
STACK: 8]
                  [0x000010D4: memset - MAX STACK DEPTH: 0  LOCAL
STACK: 0]
              [0x00002400: _malloc_r - MAX STACK DEPTH: 128  LOCAL
STACK: 40]
                [0x00002C68: _malloc_lock - MAX STACK DEPTH: 0
LOCAL STACK: 0]
                [0x00002C6C: _malloc_unlock - MAX STACK DEPTH: 0
LOCAL STACK: 0]
                [0x00003134: _sbrk_r - MAX STACK DEPTH: 32  LOCAL
STACK: 16]
                  [0x000017DC: _sbrk - MAX STACK DEPTH: 16  LOCAL
STACK: 16]
                    [0x00001BE8: _errno - MAX STACK DEPTH: 0
LOCAL STACK: 0]
                [0x00003760: _free_r - MAX STACK DEPTH: 88  LOCAL
STACK: 32]
                  [0x00002C68: _malloc_lock - MAX STACK DEPTH: 0
  LOCAL STACK: 0]
                  [0x00002C6C: _malloc_unlock - MAX STACK DEPTH:
0  LOCAL STACK: 0]
                  [0x00003650: _malloc_trim_r - MAX STACK DEPTH:
56  LOCAL STACK: 24]
                    [0x00002C68: _malloc_lock - MAX STACK
DEPTH: 0  LOCAL STACK: 0]
                    [0x00003134: _sbrk_r - MAX STACK DEPTH: 32
LOCAL STACK: 16]
                      [0x000017DC: _sbrk - MAX STACK DEPTH: 16
LOCAL STACK: 16]
                        [0x00001BE8: _errno - MAX STACK
DEPTH: 0  LOCAL STACK: 0]
                    [0x00002C6C: _malloc_unlock - MAX STACK
DEPTH: 0  LOCAL STACK: 0]
              [0x00001978: isatty - MAX STACK DEPTH: 0  LOCAL STACK:
0]
            [0x00001CF4: _sinit - MAX STACK DEPTH: 24  LOCAL STACK:
24]
              [0x00001BF8: std - MAX STACK DEPTH: 0  LOCAL STACK: 0]
          [0x00002AB4: memchr - MAX STACK DEPTH: 8  LOCAL STACK: 8]
          [0x00002B90: memmove - MAX STACK DEPTH: 8  LOCAL STACK: 8]
          [0x00002C70: _realloc_r - MAX STACK DEPTH: 176  LOCAL STACK:
48]
            [0x00002C68: _malloc_lock - MAX STACK DEPTH: 0  LOCAL
STACK: 0]
            [0x00002400: _malloc_r - MAX STACK DEPTH: 128  LOCAL STACK:
40]
              [0x00002C68: _malloc_lock - MAX STACK DEPTH: 0  LOCAL
STACK: 0]
              [0x00002C6C: _malloc_unlock - MAX STACK DEPTH: 0
LOCAL STACK: 0]
              [0x00003134: _sbrk_r - MAX STACK DEPTH: 32  LOCAL
STACK: 16]
                [0x000017DC: _sbrk - MAX STACK DEPTH: 16  LOCAL
STACK: 16]
                  [0x00001BE8: _errno - MAX STACK DEPTH: 0
LOCAL STACK: 0]
              [0x00003760: _free_r - MAX STACK DEPTH: 88  LOCAL
STACK: 32]
                [0x00002C68: _malloc_lock - MAX STACK DEPTH: 0
LOCAL STACK: 0]
                [0x00002C6C: _malloc_unlock - MAX STACK DEPTH: 0
LOCAL STACK: 0]
                [0x00003650: _malloc_trim_r - MAX STACK DEPTH: 56
LOCAL STACK: 24]
                  [0x00002C68: _malloc_lock - MAX STACK DEPTH: 0
  LOCAL STACK: 0]
                  [0x00003134: _sbrk_r - MAX STACK DEPTH: 32
LOCAL STACK: 16]
                    [0x000017DC: _sbrk - MAX STACK DEPTH: 16
LOCAL STACK: 16]
                      [0x00001BE8: _errno - MAX STACK DEPTH:
0  LOCAL STACK: 0]
                  [0x00002C6C: _malloc_unlock - MAX STACK DEPTH:
0  LOCAL STACK: 0]
            [0x00003760: _free_r - MAX STACK DEPTH: 88  LOCAL STACK:
32]
              [0x00002C68: _malloc_lock - MAX STACK DEPTH: 0  LOCAL
STACK: 0]
              [0x00002C6C: _malloc_unlock - MAX STACK DEPTH: 0
LOCAL STACK: 0]
              [0x00003650: _malloc_trim_r - MAX STACK DEPTH: 56
LOCAL STACK: 24]
                [0x00002C68: _malloc_lock - MAX STACK DEPTH: 0
LOCAL STACK: 0]
                [0x00003134: _sbrk_r - MAX STACK DEPTH: 32  LOCAL
STACK: 16]
                  [0x000017DC: _sbrk - MAX STACK DEPTH: 16  LOCAL
STACK: 16]
                    [0x00001BE8: _errno - MAX STACK DEPTH: 0
LOCAL STACK: 0]
                [0x00002C6C: _malloc_unlock - MAX STACK DEPTH: 0
LOCAL STACK: 0]
            [0x00002C6C: _malloc_unlock - MAX STACK DEPTH: 0  LOCAL
STACK: 0]
            [0x00002B90: memmove - MAX STACK DEPTH: 8  LOCAL STACK: 8]
          [0x00003570: fflush - MAX STACK DEPTH: 40  LOCAL STACK: 16]
            [0x00001CF4: _sinit - MAX STACK DEPTH: 24  LOCAL STACK:
24]
              [0x00001BF8: std - MAX STACK DEPTH: 0  LOCAL STACK: 0]
            [0x000022A4: _fwalk - MAX STACK DEPTH: 24  LOCAL STACK: 24]
              [0x00001E64: _fp_unlock - MAX STACK DEPTH: 0  LOCAL
STACK: 0]
              [0x00001E5C: _fp_lock - MAX STACK DEPTH: 0  LOCAL
STACK: 0]
              [0x00001CB4: _sfp_lock_acquire - MAX STACK DEPTH: 0
LOCAL STACK: 0]
              [0x???????? **** WARNING: INDIRECT CALL **** - MAX STACK
DEPTH: ?  LOCAL STACK: ?]
              [0x00001CB8: _sfp_lock_release - MAX STACK DEPTH: 0
LOCAL STACK: 0]
          [0x00003760: _free_r - MAX STACK DEPTH: 88  LOCAL STACK: 32]
            [0x00002C68: _malloc_lock - MAX STACK DEPTH: 0  LOCAL
STACK: 0]
            [0x00002C6C: _malloc_unlock - MAX STACK DEPTH: 0  LOCAL
STACK: 0]
            [0x00003650: _malloc_trim_r - MAX STACK DEPTH: 56  LOCAL
STACK: 24]
              [0x00002C68: _malloc_lock - MAX STACK DEPTH: 0  LOCAL
STACK: 0]
              [0x00003134: _sbrk_r - MAX STACK DEPTH: 32  LOCAL
STACK: 16]
                [0x000017DC: _sbrk - MAX STACK DEPTH: 16  LOCAL
STACK: 16]
                  [0x00001BE8: _errno - MAX STACK DEPTH: 0
LOCAL STACK: 0]
              [0x00002C6C: _malloc_unlock - MAX STACK DEPTH: 0
LOCAL STACK: 0]
  [0x0000109C: exit - MAX STACK DEPTH: 136  LOCAL STACK: 0]
    [0x00001AA0: _call_exitprocs - MAX STACK DEPTH: 136  LOCAL STACK: 32]
      [0x000023D4: free - MAX STACK DEPTH: 104  LOCAL STACK: 16]
        [0x00003760: _free_r - MAX STACK DEPTH: 88  LOCAL STACK: 32]
          [0x00002C68: _malloc_lock - MAX STACK DEPTH: 0  LOCAL STACK:
0]
          [0x00002C6C: _malloc_unlock - MAX STACK DEPTH: 0  LOCAL STACK:
0]
          [0x00003650: _malloc_trim_r - MAX STACK DEPTH: 56  LOCAL STACK:
24]
            [0x00002C68: _malloc_lock - MAX STACK DEPTH: 0  LOCAL
STACK: 0]
            [0x00003134: _sbrk_r - MAX STACK DEPTH: 32  LOCAL STACK:
16]
              [0x000017DC: _sbrk - MAX STACK DEPTH: 16  LOCAL STACK:
16]
                [0x00001BE8: _errno - MAX STACK DEPTH: 0  LOCAL
STACK: 0]
            [0x00002C6C: _malloc_unlock - MAX STACK DEPTH: 0  LOCAL
STACK: 0]
    [0x00001788: _exit - MAX STACK DEPTH: 0  LOCAL STACK: 0]
    [0x???????? **** WARNING: INDIRECT CALL **** - MAX STACK DEPTH: ?  LOCAL
STACK: ?]
[0x000012D4: initialise_monitor_handles - MAX STACK DEPTH: 48  LOCAL STACK: 48]
[0x000017A8: _kill - MAX STACK DEPTH: 12  LOCAL STACK: 12]
[0x000017D4: _getpid - MAX STACK DEPTH: 0  LOCAL STACK: 0]
[0x00001874: _stat - MAX STACK DEPTH: 104  LOCAL STACK: 16]
  [0x000016FC: _open - MAX STACK DEPTH: 88  LOCAL STACK: 24]
    [0x00001650: _swiopen - MAX STACK DEPTH: 64  LOCAL STACK: 40]
      [0x00001234: findslot - MAX STACK DEPTH: 0  LOCAL STACK: 0]
      [0x000011D4: strlen - MAX STACK DEPTH: 0  LOCAL STACK: 0]
      [0x00001398: error - MAX STACK DEPTH: 24  LOCAL STACK: 24]
        [0x00001BE8: _errno - MAX STACK DEPTH: 0  LOCAL STACK: 0]
    [0x000013D8: wrap - MAX STACK DEPTH: 24  LOCAL STACK: 0]
      [0x00001398: error - MAX STACK DEPTH: 24  LOCAL STACK: 24]
        [0x00001BE8: _errno - MAX STACK DEPTH: 0  LOCAL STACK: 0]
  [0x000010D4: memset - MAX STACK DEPTH: 0  LOCAL STACK: 0]
  [0x0000171C: _swiclose - MAX STACK DEPTH: 56  LOCAL STACK: 24]
    [0x00001260: remap_handle - MAX STACK DEPTH: 32  LOCAL STACK: 8]
      [0x00001CF4: _sinit - MAX STACK DEPTH: 24  LOCAL STACK: 24]
        [0x00001BF8: std - MAX STACK DEPTH: 0  LOCAL STACK: 0]
    [0x00001234: findslot - MAX STACK DEPTH: 0  LOCAL STACK: 0]
[0x000018D4: _link - MAX STACK DEPTH: 0  LOCAL STACK: 0]
[0x000018DC: _unlink - MAX STACK DEPTH: 0  LOCAL STACK: 0]
[0x000018E4: _raise - MAX STACK DEPTH: 0  LOCAL STACK: 0]
[0x000018E8: _gettimeofday - MAX STACK DEPTH: 20  LOCAL STACK: 20]
[0x00001938: _times - MAX STACK DEPTH: 16  LOCAL STACK: 16]
[0x00001980: _system - MAX STACK DEPTH: 16  LOCAL STACK: 16]
  [0x00001BE8: _errno - MAX STACK DEPTH: 0  LOCAL STACK: 0]
[0x000019B0: _rename - MAX STACK DEPTH: 16  LOCAL STACK: 16]
  [0x00001BE8: _errno - MAX STACK DEPTH: 0  LOCAL STACK: 0]
[0x00001CDC: _cleanup - MAX STACK DEPTH: 40  LOCAL STACK: 0]
  [0x00001CBC: _cleanup_r - MAX STACK DEPTH: 40  LOCAL STACK: 16]
    [0x000022A4: _fwalk - MAX STACK DEPTH: 24  LOCAL STACK: 24]
      [0x00001E64: _fp_unlock - MAX STACK DEPTH: 0  LOCAL STACK: 0]
      [0x00001E5C: _fp_lock - MAX STACK DEPTH: 0  LOCAL STACK: 0]
      [0x00001CB4: _sfp_lock_acquire - MAX STACK DEPTH: 0  LOCAL STACK: 0]
      [0x???????? **** WARNING: INDIRECT CALL **** - MAX STACK DEPTH: ?
LOCAL STACK: ?]
      [0x00001CB8: _sfp_lock_release - MAX STACK DEPTH: 0  LOCAL STACK: 0]
[0x00001CEC: _sinit_lock_acquire - MAX STACK DEPTH: 0  LOCAL STACK: 0]
[0x00001CF0: _sinit_lock_release - MAX STACK DEPTH: 0  LOCAL STACK: 0]
[0x00001D80: _sfp - MAX STACK DEPTH: 160  LOCAL STACK: 16]
  [0x00001CF4: _sinit - MAX STACK DEPTH: 24  LOCAL STACK: 24]
    [0x00001BF8: std - MAX STACK DEPTH: 0  LOCAL STACK: 0]
  [0x00001C54: _sfmoreglue - MAX STACK DEPTH: 144  LOCAL STACK: 16]
    [0x00002400: _malloc_r - MAX STACK DEPTH: 128  LOCAL STACK: 40]
      [0x00002C68: _malloc_lock - MAX STACK DEPTH: 0  LOCAL STACK: 0]
      [0x00002C6C: _malloc_unlock - MAX STACK DEPTH: 0  LOCAL STACK: 0]
      [0x00003134: _sbrk_r - MAX STACK DEPTH: 32  LOCAL STACK: 16]
        [0x000017DC: _sbrk - MAX STACK DEPTH: 16  LOCAL STACK: 16]
          [0x00001BE8: _errno - MAX STACK DEPTH: 0  LOCAL STACK: 0]
      [0x00003760: _free_r - MAX STACK DEPTH: 88  LOCAL STACK: 32]
        [0x00002C68: _malloc_lock - MAX STACK DEPTH: 0  LOCAL STACK: 0]
        [0x00002C6C: _malloc_unlock - MAX STACK DEPTH: 0  LOCAL STACK: 0]
        [0x00003650: _malloc_trim_r - MAX STACK DEPTH: 56  LOCAL STACK: 24]
          [0x00002C68: _malloc_lock - MAX STACK DEPTH: 0  LOCAL STACK:
0]
          [0x00003134: _sbrk_r - MAX STACK DEPTH: 32  LOCAL STACK: 16]
            [0x000017DC: _sbrk - MAX STACK DEPTH: 16  LOCAL STACK: 16]
              [0x00001BE8: _errno - MAX STACK DEPTH: 0  LOCAL STACK:
0]
          [0x00002C6C: _malloc_unlock - MAX STACK DEPTH: 0  LOCAL STACK:
0]
    [0x000010D4: memset - MAX STACK DEPTH: 0  LOCAL STACK: 0]
[0x00001E6C: _fp_lock_all - MAX STACK DEPTH: 40  LOCAL STACK: 16]
  [0x000022A4: _fwalk - MAX STACK DEPTH: 24  LOCAL STACK: 24]
    [0x00001E64: _fp_unlock - MAX STACK DEPTH: 0  LOCAL STACK: 0]
    [0x00001E5C: _fp_lock - MAX STACK DEPTH: 0  LOCAL STACK: 0]
    [0x00001CB4: _sfp_lock_acquire - MAX STACK DEPTH: 0  LOCAL STACK: 0]
    [0x???????? **** WARNING: INDIRECT CALL **** - MAX STACK DEPTH: ?  LOCAL
STACK: ?]
    [0x00001CB8: _sfp_lock_release - MAX STACK DEPTH: 0  LOCAL STACK: 0]
[0x00001E98: _fp_unlock_all - MAX STACK DEPTH: 40  LOCAL STACK: 16]
  [0x000022A4: _fwalk - MAX STACK DEPTH: 24  LOCAL STACK: 24]
    [0x00001E64: _fp_unlock - MAX STACK DEPTH: 0  LOCAL STACK: 0]
    [0x00001E5C: _fp_lock - MAX STACK DEPTH: 0  LOCAL STACK: 0]
    [0x00001CB4: _sfp_lock_acquire - MAX STACK DEPTH: 0  LOCAL STACK: 0]
    [0x???????? **** WARNING: INDIRECT CALL **** - MAX STACK DEPTH: ?  LOCAL
STACK: ?]
    [0x00001CB8: _sfp_lock_release - MAX STACK DEPTH: 0  LOCAL STACK: 0]
[0x00002320: _fwalk_reent - MAX STACK DEPTH: 32  LOCAL STACK: 32]
  [0x00001CB4: _sfp_lock_acquire - MAX STACK DEPTH: 0  LOCAL STACK: 0]
  [0x00001CB8: _sfp_lock_release - MAX STACK DEPTH: 0  LOCAL STACK: 0]
[0x0000317C: _sread - MAX STACK DEPTH: 112  LOCAL STACK: 8]
  [0x00003B50: _read_r - MAX STACK DEPTH: 104  LOCAL STACK: 16]
    [0x00001424: _read - MAX STACK DEPTH: 88  LOCAL STACK: 24]
      [0x00001260: remap_handle - MAX STACK DEPTH: 32  LOCAL STACK: 8]
        [0x00001CF4: _sinit - MAX STACK DEPTH: 24  LOCAL STACK: 24]
          [0x00001BF8: std - MAX STACK DEPTH: 0  LOCAL STACK: 0]
      [0x00001234: findslot - MAX STACK DEPTH: 0  LOCAL STACK: 0]
      [0x000013E4: _swiread - MAX STACK DEPTH: 64  LOCAL STACK: 32]
        [0x00001260: remap_handle - MAX STACK DEPTH: 32  LOCAL STACK: 8]
          [0x00001CF4: _sinit - MAX STACK DEPTH: 24  LOCAL STACK: 24]
            [0x00001BF8: std - MAX STACK DEPTH: 0  LOCAL STACK: 0]
      [0x00001398: error - MAX STACK DEPTH: 24  LOCAL STACK: 24]
        [0x00001BE8: _errno - MAX STACK DEPTH: 0  LOCAL STACK: 0]
[0x000031C8: _swrite - MAX STACK DEPTH: 128  LOCAL STACK: 24]
  [0x000032B4: _write_r - MAX STACK DEPTH: 104  LOCAL STACK: 16]
    [0x000015D0: _write - MAX STACK DEPTH: 88  LOCAL STACK: 24]
      [0x00001260: remap_handle - MAX STACK DEPTH: 32  LOCAL STACK: 8]
        [0x00001CF4: _sinit - MAX STACK DEPTH: 24  LOCAL STACK: 24]
          [0x00001BF8: std - MAX STACK DEPTH: 0  LOCAL STACK: 0]
      [0x00001234: findslot - MAX STACK DEPTH: 0  LOCAL STACK: 0]
      [0x00001590: _swiwrite - MAX STACK DEPTH: 64  LOCAL STACK: 32]
        [0x00001260: remap_handle - MAX STACK DEPTH: 32  LOCAL STACK: 8]
          [0x00001CF4: _sinit - MAX STACK DEPTH: 24  LOCAL STACK: 24]
            [0x00001BF8: std - MAX STACK DEPTH: 0  LOCAL STACK: 0]
      [0x00001398: error - MAX STACK DEPTH: 24  LOCAL STACK: 24]
        [0x00001BE8: _errno - MAX STACK DEPTH: 0  LOCAL STACK: 0]
  [0x000039A8: _lseek_r - MAX STACK DEPTH: 96  LOCAL STACK: 16]
    [0x00001578: _lseek - MAX STACK DEPTH: 80  LOCAL STACK: 16]
      [0x000014A0: _swilseek - MAX STACK DEPTH: 64  LOCAL STACK: 32]
        [0x00001260: remap_handle - MAX STACK DEPTH: 32  LOCAL STACK: 8]
          [0x00001CF4: _sinit - MAX STACK DEPTH: 24  LOCAL STACK: 24]
            [0x00001BF8: std - MAX STACK DEPTH: 0  LOCAL STACK: 0]
        [0x00001234: findslot - MAX STACK DEPTH: 0  LOCAL STACK: 0]
      [0x000013D8: wrap - MAX STACK DEPTH: 24  LOCAL STACK: 0]
        [0x00001398: error - MAX STACK DEPTH: 24  LOCAL STACK: 24]
          [0x00001BE8: _errno - MAX STACK DEPTH: 0  LOCAL STACK: 0]
[0x00003238: _sseek - MAX STACK DEPTH: 104  LOCAL STACK: 8]
  [0x000039A8: _lseek_r - MAX STACK DEPTH: 96  LOCAL STACK: 16]
    [0x00001578: _lseek - MAX STACK DEPTH: 80  LOCAL STACK: 16]
      [0x000014A0: _swilseek - MAX STACK DEPTH: 64  LOCAL STACK: 32]
        [0x00001260: remap_handle - MAX STACK DEPTH: 32  LOCAL STACK: 8]
          [0x00001CF4: _sinit - MAX STACK DEPTH: 24  LOCAL STACK: 24]
            [0x00001BF8: std - MAX STACK DEPTH: 0  LOCAL STACK: 0]
        [0x00001234: findslot - MAX STACK DEPTH: 0  LOCAL STACK: 0]
      [0x000013D8: wrap - MAX STACK DEPTH: 24  LOCAL STACK: 0]
        [0x00001398: error - MAX STACK DEPTH: 24  LOCAL STACK: 24]
          [0x00001BE8: _errno - MAX STACK DEPTH: 0  LOCAL STACK: 0]
[0x00003288: _sclose - MAX STACK DEPTH: 104  LOCAL STACK: 16]
  [0x00003404: _close_r - MAX STACK DEPTH: 88  LOCAL STACK: 16]
    [0x00001710: _close - MAX STACK DEPTH: 72  LOCAL STACK: 16]
      [0x0000171C: _swiclose - MAX STACK DEPTH: 56  LOCAL STACK: 24]
        [0x00001260: remap_handle - MAX STACK DEPTH: 32  LOCAL STACK: 8]
          [0x00001CF4: _sinit - MAX STACK DEPTH: 24  LOCAL STACK: 24]
            [0x00001BF8: std - MAX STACK DEPTH: 0  LOCAL STACK: 0]
        [0x00001234: findslot - MAX STACK DEPTH: 0  LOCAL STACK: 0]
      [0x000013D8: wrap - MAX STACK DEPTH: 24  LOCAL STACK: 0]
        [0x00001398: error - MAX STACK DEPTH: 24  LOCAL STACK: 24]
          [0x00001BE8: _errno - MAX STACK DEPTH: 0  LOCAL STACK: 0]
[0x00003558: fclose - MAX STACK DEPTH: 104  LOCAL STACK: 0]
  [0x0000344C: _fclose_r - MAX STACK DEPTH: 104  LOCAL STACK: 16]
    [0x00001CB4: _sfp_lock_acquire - MAX STACK DEPTH: 0  LOCAL STACK: 0]
    [0x00001CB8: _sfp_lock_release - MAX STACK DEPTH: 0  LOCAL STACK: 0]
    [0x00001CF4: _sinit - MAX STACK DEPTH: 24  LOCAL STACK: 24]
      [0x00001BF8: std - MAX STACK DEPTH: 0  LOCAL STACK: 0]
    [0x00003760: _free_r - MAX STACK DEPTH: 88  LOCAL STACK: 32]
      [0x00002C68: _malloc_lock - MAX STACK DEPTH: 0  LOCAL STACK: 0]
      [0x00002C6C: _malloc_unlock - MAX STACK DEPTH: 0  LOCAL STACK: 0]
      [0x00003650: _malloc_trim_r - MAX STACK DEPTH: 56  LOCAL STACK: 24]
        [0x00002C68: _malloc_lock - MAX STACK DEPTH: 0  LOCAL STACK: 0]
        [0x00003134: _sbrk_r - MAX STACK DEPTH: 32  LOCAL STACK: 16]
          [0x000017DC: _sbrk - MAX STACK DEPTH: 16  LOCAL STACK: 16]
            [0x00001BE8: _errno - MAX STACK DEPTH: 0  LOCAL STACK: 0]
        [0x00002C6C: _malloc_unlock - MAX STACK DEPTH: 0  LOCAL STACK: 0]
    [0x???????? **** WARNING: INDIRECT CALL **** - MAX STACK DEPTH: ?  LOCAL
STACK: ?]
    [0x00003570: fflush - MAX STACK DEPTH: 40  LOCAL STACK: 16]
      [0x00001CF4: _sinit - MAX STACK DEPTH: 24  LOCAL STACK: 24]
        [0x00001BF8: std - MAX STACK DEPTH: 0  LOCAL STACK: 0]
      [0x000022A4: _fwalk - MAX STACK DEPTH: 24  LOCAL STACK: 24]
        [0x00001E64: _fp_unlock - MAX STACK DEPTH: 0  LOCAL STACK: 0]
        [0x00001E5C: _fp_lock - MAX STACK DEPTH: 0  LOCAL STACK: 0]
        [0x00001CB4: _sfp_lock_acquire - MAX STACK DEPTH: 0  LOCAL STACK:
0]
        [0x???????? **** WARNING: INDIRECT CALL **** - MAX STACK DEPTH: ?
LOCAL STACK: ?]
        [0x00001CB8: _sfp_locK_release - MAX STACK DEPTH: 0  LOCAL STACK:
0]
[0x00003BE0: _reclaim_reent - MAX STACK DEPTH: 120  LOCAL STACK: 16]
  [0x00003760: _free_r - MAX STACK DEPTH: 88  LOCAL STACK: 32]
    [0x00002C68: _malloc_lock - MAX STACK DEPTH: 0  LOCAL STACK: 0]
    [0x00002C6C: _malloc_unlock - MAX STACK DEPTH: 0  LOCAL STACK: 0]
    [0x00003650: _malloc_trim_r - MAX STACK DEPTH: 56  LOCAL STACK: 24]
      [0x00002C68: _malloc_lock - MAX STACK DEPTH: 0  LOCAL STACK: 0]
      [0x00003134: _sbrk_r - MAX STACK DEPTH: 32  LOCAL STACK: 16]
        [0x000017DC: _sbrk - MAX STACK DEPTH: 16  LOCAL STACK: 16]
          [0x00001BE8: _errno - MAX STACK DEPTH: 0  LOCAL STACK: 0]
      [0x00002C6C: _malloc_unlock - MAX STACK DEPTH: 0  LOCAL STACK: 0]
  [0x00003BA4: cleanup_glue - MAX STACK DEPTH: 104  LOCAL STACK: 16]
    [0x00003760: _free_r - MAX STACK DEPTH: 88  LOCAL STACK: 32]
      [0x00002C68: _malloc_lock - MAX STACK DEPTH: 0  LOCAL STACK: 0]
      [0x00002C6C: _malloc_unlock - MAX STACK DEPTH: 0  LOCAL STACK: 0]
      [0x00003650: _malloc_trim_r - MAX STACK DEPTH: 56  LOCAL STACK: 24]
        [0x00002C68: _malloc_lock - MAX STACK DEPTH: 0  LOCAL STACK: 0]
        [0x00003134: _sbrk_r - MAX STACK DEPTH: 32  LOCAL STACK: 16]
          [0x000017DC: _sbrk - MAX STACK DEPTH: 16  LOCAL STACK: 16]
            [0x00001BE8: _errno - MAX STACK DEPTH: 0  LOCAL STACK: 0]
        [0x00002C6C: _malloc_unlock - MAX STACK DEPTH: 0  LOCAL STACK: 0]
    [0x00003BA4: cleanup_glue - MAX STACK DEPTH: 104  LOCAL STACK: 161  ****
WARNING: RECURSIVE ****]
[0x00003CD8: _wrapup_reent - MAX STACK DEPTH: 24  LOCAL STACK: 24]
  [0x???????? **** WARNING: INDIRECT CALL **** - MAX STACK DEPTH: ?  LOCAL
STACK: ?]
  [0x00003EA8: _aeabi_uidivmod - MAX STACK DEPTH: 24  LOCAL STACK: 12]
    [0x00003DAC: _aeabi_uidiv - MAX STACK DEPTH: 12  LOCAL STACK: 12]
[0x00003ECO: _aeabi_idiv0 - MAX STACK DEPTH: 0  LOCAL STACK: 0]
Total Indirect Function Call Warnings: 8
Total Recursive Function Call Warnings: 1
```

While the invention herein disclosed has been described by means of specific embodiments, examples and applications thereof, numerous modifications and variations could be made thereto by those skilled in the art without departing from the scope of the invention set forth in the claims.

What is claimed is:

1. A method to facilitate memory allocation, the method comprising:
examining an executable program file configured to be executed by a processor to identify a group of functions present within the executable program file;
calculating memory requirements for each function of the group of functions;
identifying a plurality of root functions as functions of the group of functions which are not referred to by other functions of the group of functions;
creating a function call tree for each of the plurality of root functions, wherein each of the function call trees comprise functions of the group of functions which are directly or indirectly referred to by an associated one of the plurality of root functions; and
calculating memory requirements for one or more function call paths of each of the function call trees based upon the calculated memory requirements of the functions included within the one or more function call paths.

2. The method according to claim 1, further comprising:
estimating memory requirements for each of the function call trees based upon which of the calculated memory requirements of the one or more function call paths requires a greatest amount of memory.

3. The method according to claim 1, further comprising:
estimating stack memory requirements for each of the function call trees based upon which of the calculated memory requirements of the one or more function call paths requires a greatest amount of memory.

4. The method according to claim 1, further comprising:
identifying if a function call individually contained within an associated function of the group of functions directly or indirectly refers to itself such that the function call directly or indirectly refers to the function within which it is contained.

5. The method according to claim 1, further comprising:
obtaining starting and ending memory addresses of each function of the group of functions; and
identifying the group of functions based upon the starting and ending memory addresses of each of the group of functions.

6. The method according to claim 1, further comprising:
scanning a portion of the executable program file associated with each function of the group of functions to identify instructions modifying a memory address pointer; and
calculating the memory requirements for each function of the group of functions based upon an amount of the modifying of the memory address pointer.

7. The method according to claim 1, wherein the creating the function call tree for each of the plurality of root functions comprises:
identifying a group of function calls individually contained within a function of the group of functions and which individually refer to a particular function of the group of functions.

8. The method according to claim 6, further comprising:
identifying branch-and-link instructions individually contained within a particular function of the group of functions; and
identifying the group of function calls based upon the identified branch-and-link instructions.

9. The method according to claim 1, further comprising:
linking a first call tree of the function call trees with a second call tree of the function call trees by causing a particular function of the first call tree to refer to function of the second call tree; and
calculating memory requirements for one or more function call paths of the first call tree based upon the calculated memory requirements of the functions included within the one or more function call paths of the first call tree.

10. The method according to claim 1, further comprising:
determining a memory overflow error that would be caused by execution of the executable program file based upon the memory requirements for one or more function call paths of at least one of the function call trees exceeding a memory threshold.

11. The method according to claim 1, wherein the executable program file is configured to execute within an embedded system.

12. The method according to claim 1, wherein the memory requirements for one or more function call paths comprise a stack size.

13. The method according to claim 1, wherein the identifying the group of functions present within an executable program file comprises:
scanning binary image data comprising the executable program file.

14. The method according to claim 1, wherein the group of functions comprise functions associated with source code and at least one compiler-added function which is added to the executable program file by a compiler of the source code.

15. A computer-readable medium for facilitating memory allocation, the computer-readable medium tangibly storing instructions which, when executed by a processor, cause the processor to perform:
examining an executable program file configured to be executed by a processor to identify a group of functions present within the executable program file;
calculating memory requirements for each function of the group of functions;
identifying a plurality of root functions as functions of the group of functions which are not referred to by other functions of the group of functions;
creating a function call tree for each of the plurality of root functions, wherein each of the function call trees comprise functions of the group of functions which are directly or indirectly referred to by an associated one of the plurality of root functions; and
calculating memory requirements for one or more function call paths of each of the function call trees based upon the calculated memory requirements of the functions included within the one or more function call paths.

16. The computer-readable medium according to claim 15, the instructions further causing the processor to perform:
estimating memory requirements for each of the function call trees based upon which of the calculated memory requirements of the one or more function call paths requires a greatest amount of memory.

17. The computer-readable medium according to claim 15, the instructions further causing the processor to perform:
identifying if a function call individually contained within an associated function of the group of functions directly or indirectly refers to itself such that the function call directly or indirectly refers to the function within which it is contained.

18. The computer-readable medium according to claim 15, the instructions further causing the processor to perform:
obtaining starting and ending memory addresses of each function of the group of functions; and
identifying the group of functions based upon the starting and ending memory addresses of each of the group of functions.

19. The computer-readable medium according to claim 15, the instructions further causing the processor to perform:
scanning a portion of the executable program file associated with each function of the group of functions to identify instructions modifying a memory address pointer; and
calculating the memory requirements for each function of the group of functions based upon an amount of the modifying of the memory address pointer.

20. The computer-readable medium according to claim 15, wherein the creating the function call tree for each of the plurality of root functions comprises:
identifying a group of function calls individually contained within a function of the group of functions and which individually refer to a particular function of the group of functions.

21. The computer-readable medium according to claim 15, the instructions further causing the processor to perform:
linking a first call tree of the function call trees with a second call tree of the function call trees by causing a particular function of the first call tree to refer to function of the second call tree; and
calculating memory requirements for one or more function call paths of the first call tree based upon the calculated memory requirements of the functions included within the one or more function call paths of the first call tree.

22. The computer-readable medium according to claim 15, the instructions further causing the processor to perform:
determining a memory overflow error that would be caused by execution of the executable program file based upon the memory requirements for one or more function call paths of at least one of the function call trees exceeding a memory threshold.

23. The computer-readable medium according to claim 15, wherein the executable program file is configured to execute within an embedded system.

24. A method to facilitate memory allocation, the method comprising:
examining an executable program file configured to be executed by a processor located within an embedded system to identify a group of functions present within the executable program file;
calculating stack memory requirements for each function of the group of functions;
identifying a plurality of root functions as functions of the group of functions which are not referred to by other functions of the group of functions;
creating a function call tree for each of the plurality of root functions, wherein each of the function call trees comprise functions of the group of functions which are directly or indirectly referred to by an associated one of the plurality of root functions;
calculating stack memory requirements for one or more function call paths of each of the function call trees based upon the calculated stack memory requirements of the functions included within the one or more function call paths;
estimating stack memory requirements for each of the function call trees based upon which of the calculated stack memory requirements of the one or more function call paths requires a greatest amount of memory; and
determining a memory overflow error that would be caused by execution of the executable program file based upon the stack memory requirements for one or more function call paths of at least one of the function call trees exceeding a memory threshold.
